(19) United States
(12) Patent Application Publication
(10) Pub. No.: US 2007/0116534 A1
(43) Pub. Date: May 24, 2007

(54) Vehicle with low, flat floor and ramp for persons with disabilities or for other uses

(76) Inventors: Michael A. Pocobello, Ellsworth, MI (US); Patton R. Corrigan, Greenwich, CT (US)

Correspondence Address: BLANK ROME LLP, 600 NEW HAMPSHIRE AVENUE, N.W., WASHINGTON, DC, 20037, US

(21) Appl. No.: 11/521,587

(22) Filed: Sep. 15, 2006

Related U.S. Application Data
(60) Provisional application No. 60/734,284, filed on Nov. 8, 2005.

(51) Int. Cl. B60P 1/00

(52) U.S. Cl. 410/1

(57) ABSTRACT

A taxicab or other vehicle is designed specifically for persons with disabilities, although it can have other uses, e.g., a delivery vehicle. A ramp, stored in a cartridge under the vehicle floor, is extended to the curb to accommodate a wheelchair or other mobility aid. The floor is low enough that the slope of the ramp does not exceed regulations. The floor is lowered by providing a joint in the drive shaft to lower the drive shaft and eliminate the drive-train hump. An enclosure with a rotating window is provided to separate the driver from the front passenger area. The driver can unlock the doors on only one side to prevent a passenger from opening a door into traffic.

### REFERENCE TO RELATED APPLICATION

The present application claims the benefit of U.S. Provisional Patent Application No. 60/734,284, filed Nov. 8, 2005, whose disclosure is hereby incorporated by reference in its entirety into the present disclosure.

### FIELD OF THE INVENTION

The present invention is directed to a vehicle, such as a taxicab, having a low, flat floor and a ramp, designed for purposes such as accommodating a person using a mobility aid. For the purpose of the present disclosure, a mobility aid is any aid for personal mobility, such as a wheelchair or a scooter for disabled persons.

### DESCRIPTION OF RELATED ART

Taxicabs are typically modified versions of vehicles that were not initially designed with the needs of taxicab drivers and passengers in mind. A common example is the Ford Crown Victoria.

Such vehicles are typically designed for and marketed to a variety of purchasers, including individual buyers, police forces, and car rental companies. Vehicles designed for other purchasers, particularly individuals, are designed to meet criteria not related to, and sometimes at cross purposes with, the needs of taxicab drivers and passengers. In particular, individual buyers may select a car more for image than for practical concerns. Also, police forces may be concerned with performance at speeds higher than those at which taxicabs are normally operated.

Moreover, such vehicles are typically not designed to accommodate passengers in wheelchairs or other mobility devices. A passenger car typically has bench seating in the rear, which makes it difficult to move a wheelchair-using passenger into or out of the vehicle.

Another problem is that while taxicab drivers typically prefer rear-wheel-drive vehicles, such vehicles have a drive-train hump in the floor. A drive-train hump seriously impedes entry into the vehicle by a passenger using a mobility aid.

Still another problem is that traditional passenger sedans are not built with the Americans with Disabilities Act (ADA) in mind. Regulations under the ADA specify various requirements for vehicles for persons with disabilities. For example, a “box” or empty space of specified dimensions must be provided for a wheelchair. Also, if a ramp is extended from the vehicle to the curb, the ramp must have a slope not exceeding 1:4.

Retrofitting a normal passenger sedan to meet such requirements is prohibitively expensive, if not outright impossible. For one thing, if the floor of the vehicle is raised to remove the drive-train hump, then a ramp of reasonable length will have a slope exceeding 1:4.

Even if a vehicle existed that met the above requirement, or could be retrofitted in a cost-effective manner to do so, the fact would remain that different countries have different legal requirements for vehicles. In particular, national laws differ on whether a vehicle should be equipped to be driven on the left or right side of the road. Since a manufacturer that hopes to sell internationally must build vehicles complying with the laws in effect in each of its target markets, manufacturing is significantly complicated.

Yet another problem specific to taxicabs is that passengers often try to exit the vehicle from the wrong side, e.g., the side facing traffic rather than the curb side. Some taxicab drivers report a high rate of collisions when passengers open doors into traffic. Vehicles marketed to families have child safety locks, but such locks do not address that problem.

### SUMMARY OF THE INVENTION

There thus exists a need in the art to address the above problems. It is therefore an object of the invention to provide a vehicle designed specifically to address those problems.

To achieve the above and other objects, the present invention is directed to a vehicle designed specifically to serve as a taxicab for persons with disabilities.

The floor of the vehicle is designed to provide a large, flat floor space for a wheelchair. Anchor points are provided to secure the wheelchair.

A ramp is provided in the vehicle to allow access by the wheelchair-bound passenger. To simplify manufacturing, the ramp and the rails on which it moves are manufactured as a single cartridge or modular unit. If a manufacturer desires to build vehicles for both left-hand-drive and right-hand-drive markets, the positioning of the cartridge can easily be reversed. The floor of the vehicle is sufficiently low that the slope of the ramp does not exceed the maximum allowable value (1:4 in the United States).

Since the above features of the invention would appear to be mutually exclusive in a rear-wheel-drive vehicle, the drive train is designed to accommodate both. The engine and transmission are mounted in a tilted configuration so that the drive shaft extends from the transmission with a downward slope. The drive shaft is jointed so that at a point between the transmission and the differential, the downward slope changes to an upward slope. The differential is configured so that the drive shaft joins the differential at a lower portion of the differential. Such a configuration lowers the floor and offers an additional advantage in allowing the use of conventional suspension components, e.g., leaf springs.

An enclosure for the driver is provided, also in a modular configuration that can easily be mounted in the vehicle. Since some jurisdictions require a partition between the driver and the passengers, while others forbid it, a partition can be provided or not, as needed. The partition window between the driver and the front passenger location is mounted on a single pivot point, so that it can be rotated out of the way instead of being raised and lowered linearly. A conventional coin slot can be provided as needed.

The driver's enclosure can be designed to integrate an HVAC duct for the passenger compartment of the vehicle. The enclosure can also be configured to function as an office for the driver, with spaces for storing items that the driver routinely needs with in easy reach of the driver.

Door locks are under individual control by the driver. At the end of the passenger's journey, the driver can unlock only the door on the curb side, to prevent the passenger from opening a door into traffic. Indicator lights can be provided, both inside the vehicle to indicate to the passenger where to exit and outside the vehicle to indicate to drivers which door is about to open.

Other cost-saving measures can be implemented. For example, the front and rear bumpers are designed to be identical. Also, door panels and fenders are designed so that only two kinds need to be produced, which are mirror images of each other. All glass, including the windshield, is flat.

### BRIEF DESCRIPTION OF THE DRAWINGS

A preferred embodiment of the present invention will be disclosed in detail with reference to the drawings, in which:

FIGS. 1A and 1B show two views of a vehicle according to the preferred embodiment;

FIGS. 2A and 2B show the exterior body panels of the vehicle;

FIG. 3 shows the body of the vehicle;

FIG. 4 shows the chassis of the vehicle;

FIGS. 5A-5D show a wheelchair-bound passenger entering the vehicle;

FIGS. 6A and 6B show the ramp;

FIGS. 7A and 7B show the frame of the cartridge in which the ramp is mounted;

FIG. 8 shows the cartridge;

FIG. 9 shows a motorized variation of the ramp;

FIGS. 10A-10C show the driver's enclosure;

FIG. 11 shows a control panel to allow the driver to lock and unlock the doors of the vehicle; and

FIG. 12 shows the layout of the interior seating area.

### DETAILED DESCRIPTION OF THE PREFERRED EMBODIMENT

A preferred embodiment will be disclosed in detail with reference to the drawings, in which like reference numerals refer to like elements throughout.

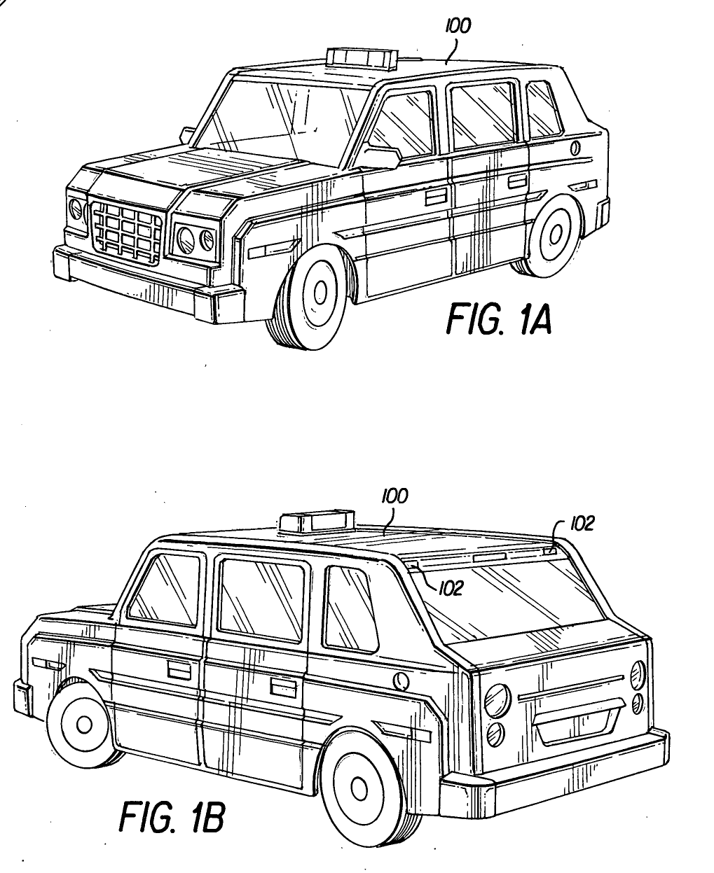

FIGS. 1A and 1B show two views of a vehicle 100 according to the preferred embodiment. As can be seen from the figures, and as will become clearer below, the vehicle is optimized for efficient and cost-effective use as a taxicab for persons with disabilities rather than as a personal pleasure vehicle.

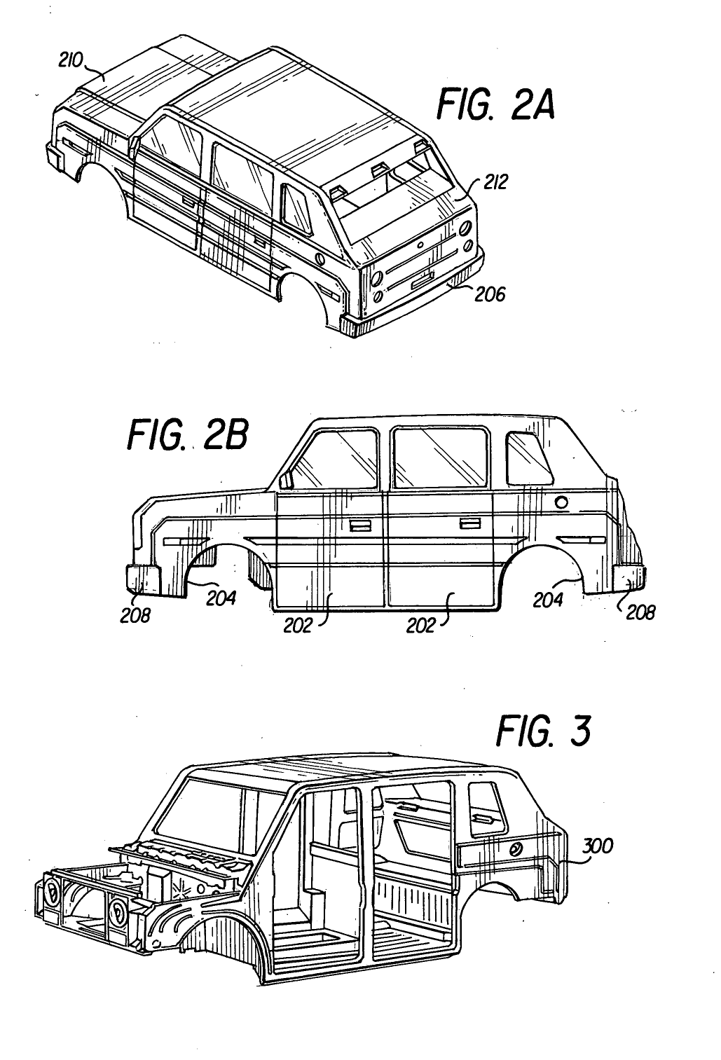

FIGS. 2A and 2B show the exterior body panels of the vehicle. The door outer panels 202, fenders 204, bumpers 206, and bumper corners 208 are replaceable and interchangeable. The body replacement parts are shipped primed, ready for paint. The hood 210 and trunk lid 212 are formed of a sheet molding compound.

FIG. 3 shows the body 300, which is constructed through all steel welded body construction.

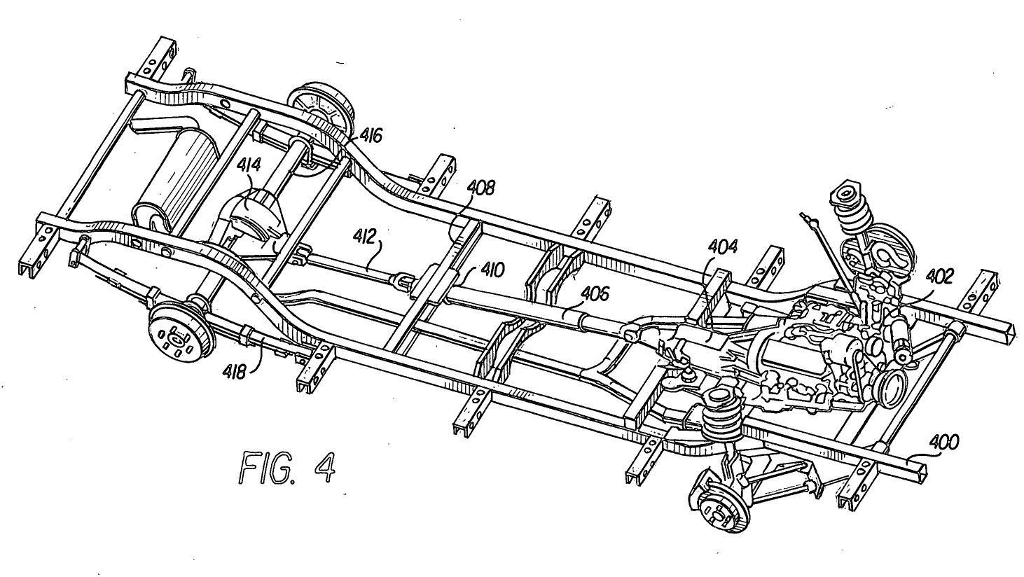

The body 300 is mounted on the frame (chassis) 400 of FIG. 4. The chassis is designed to allow a low, flat floor in a rear-wheel-drive vehicle. The engine 402 and transmission 404 are mounted on the chassis 400 in a tilted configuration so that the first section 406 of the drive shaft extends from the transmission 404 with a downward slope. At the bracing member 408 of the chassis 400, the first section 406 of the drive shaft is joined through a rotary joint 410 to a second section 412 of the drive shaft. The second section 412 of the drive shaft connects to a differential 414 at a lower portion of the differential. The rear axle 416 is supported on leaf springs 418.

The transmission 404 is an automatic transmission calibrated to the taxi driving cycle. The engine 402 and transmission 404 are designed to give good acceleration at low speeds to allow the vehicle to enter urban traffic. Generally, for taxicabs, acceleration to high speeds (e.g., 0-60 mph) is less important than acceleration to low speeds (e.g., 0-20 mph).

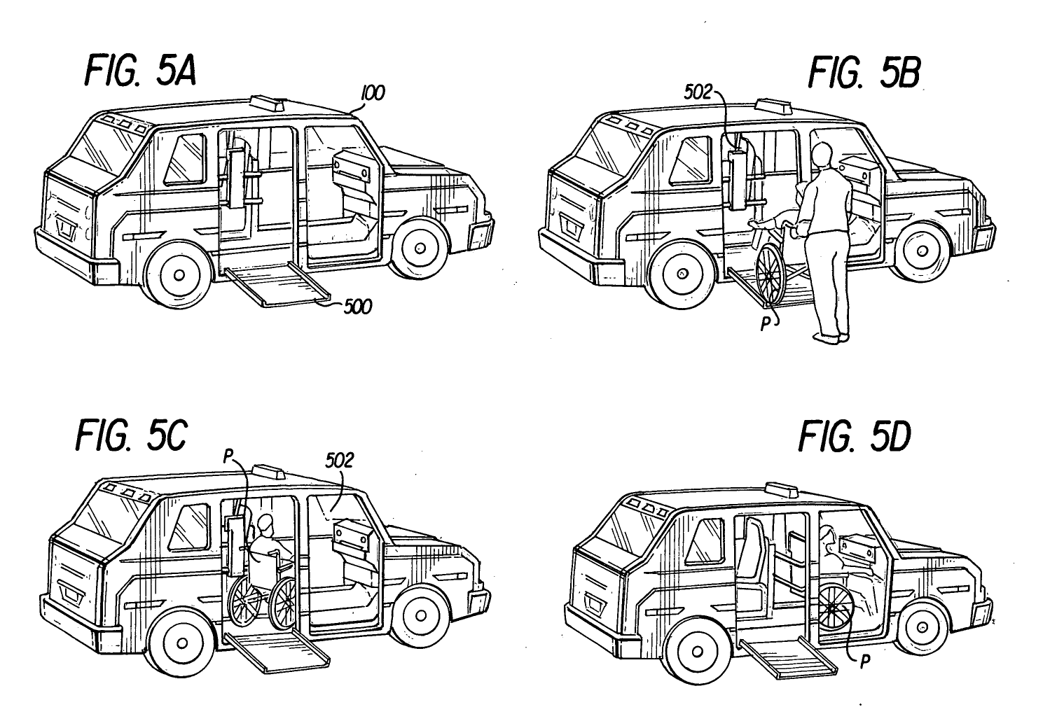

FIGS. 5A-5D show how a wheelchair-bound passenger P enters the vehicle 100. In FIG. 5A, a ramp 500, whose construction will be explained in detail below, is extended from the vehicle to the curb. In FIG. 5B, the passenger P is pushed up the ramp into an interior space 502 of the vehicle. In FIG. 5C, the passenger P is entirely in the vehicle and is moving from the back seat area to the front seat area. In FIG. 5D, the passenger P is in the front seat area. The manner in which the passenger P's wheelchair is secured to the floor of the vehicle will also be explained below.

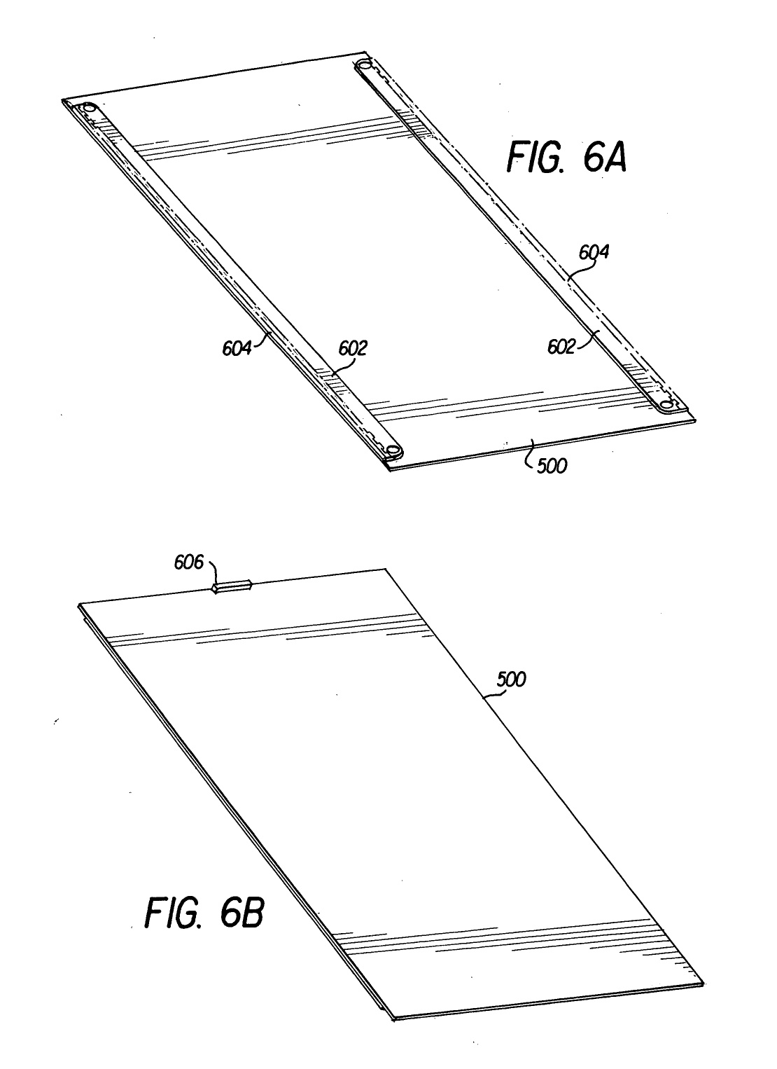

FIG. 6A shows the ramp 500 from above. The ramp has rails 602, as required by the ADA regulations. The rails 602 are spring-mounted on hinges 604 so that they can pop up when the ramp is extended and can be folded down when the ramp is not extended. Thus, the ADA requirement for rails can be met in a space-efficient manner. FIG. 6B shows the ramp 500 from below, with a center stop 606 at the end distal from the vehicle.

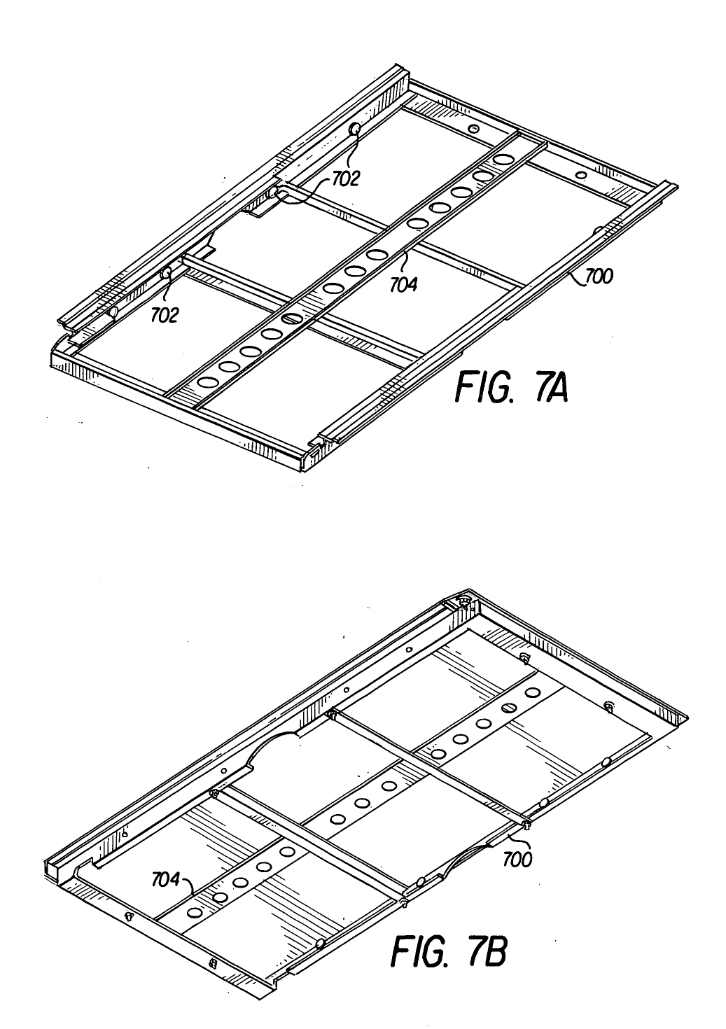

FIGS. 7A and 7B show views from above and below of a frame 700 of the cartridge in which the ramp is mounted. The frame 700 includes roller bearings 702 for supporting the ramp as it is pulled out of the vehicle and pushed back in. The frame also includes a center guide rail 704 for guiding the movement of the ramp.

FIG. 8 shows the cartridge 800, including an upper surface 802. A portion of the frame 700 is visible. At the end of the cartridge from which the ramp extends is a door 804 that is closed when the ramp is not extended. When the ramp is extended, the door 804 can act as a threshold. Latches 806 hold the door 804 closed when the ramp is not extended.

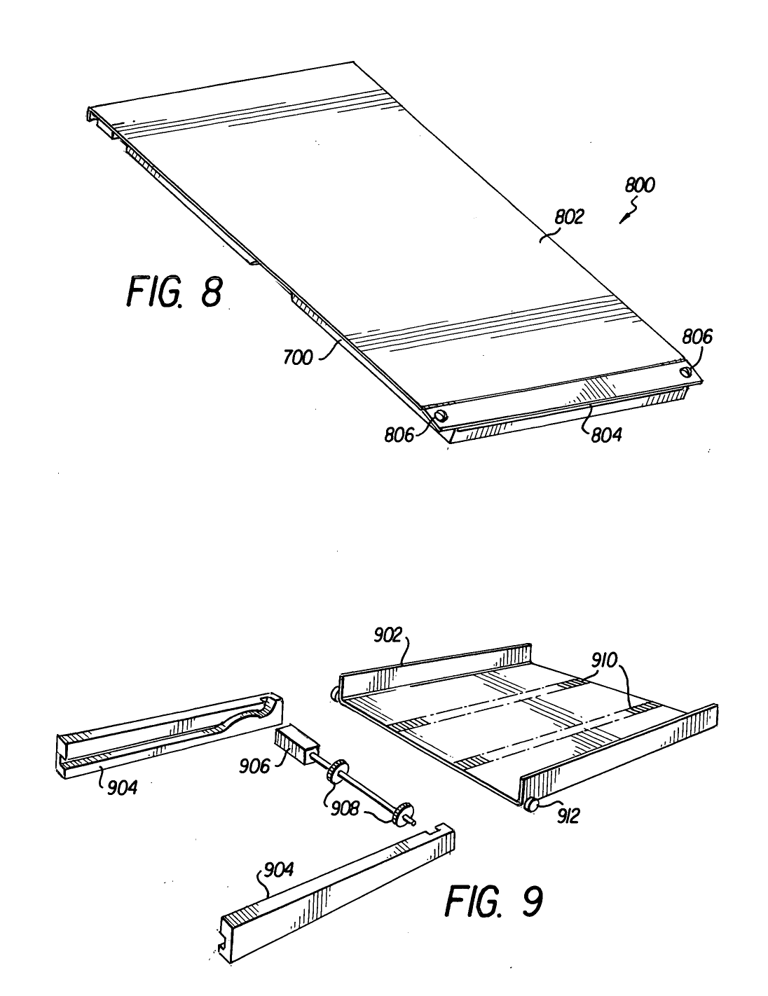

It is contemplated that the ramp will be extended and withdrawn manually. Straps (not shown) can be provided on the distal end of the ramp for that purpose. As an alternative, however, the ramp can be motorized, as shown in FIG. 9. The ramp 902 slides in an out while being guided on guides 904. A motor 906 turns gears 908, which engage with gear teeth or slots 910 on the bottom face of the ramp. The ramp also has guide wheels or pins 912.

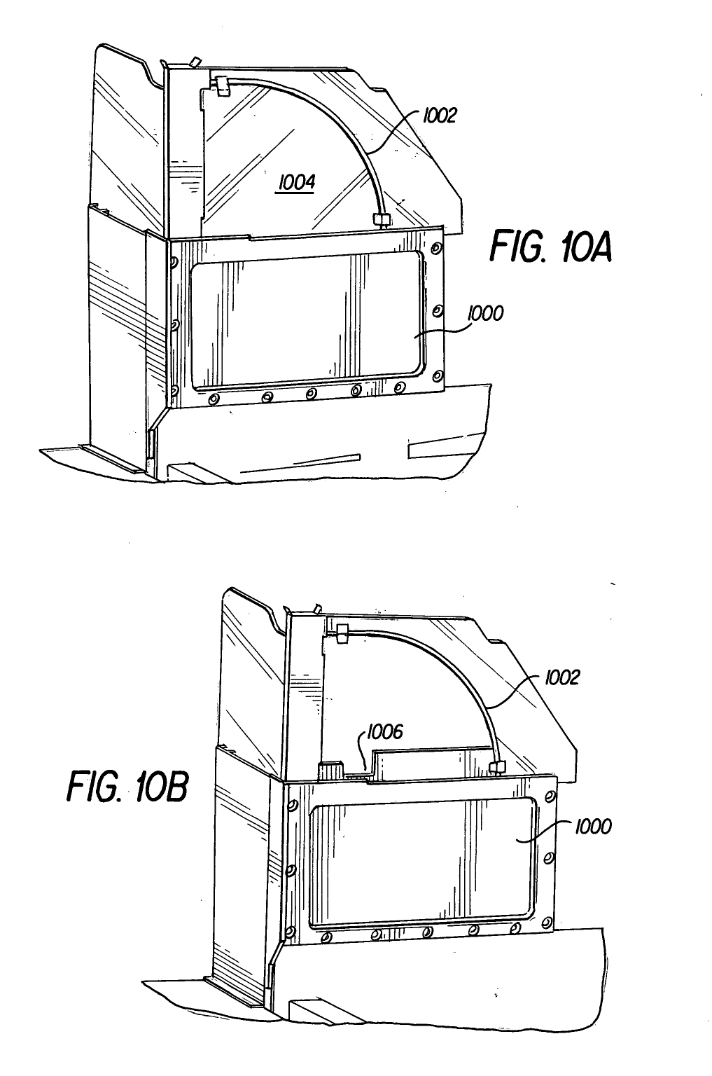

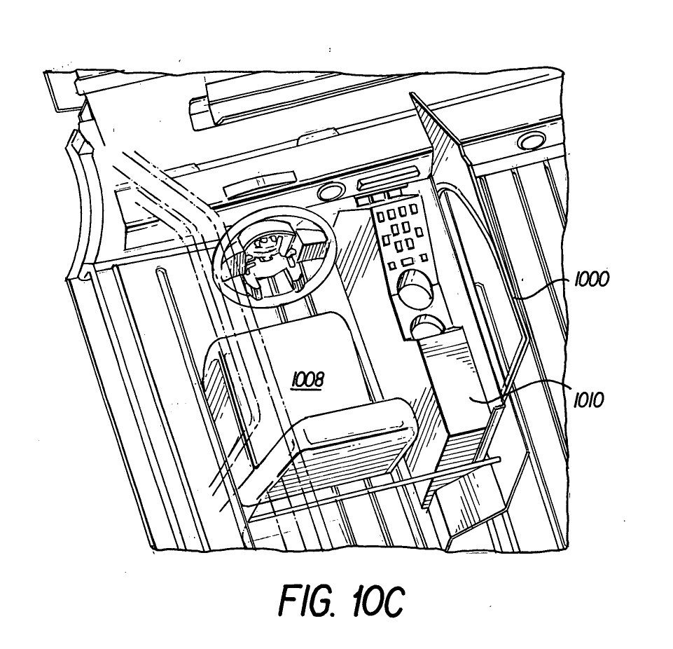

FIGS. 10A and 10B show the driver's enclosure 1000. The enclosure has a guide 1002 for supporting a window 1004 that can be rotated out of the way, as shown in FIG. 10B. The enclosure provides for a change slot 1006.

The enclosure does not enclose the entire front area of the vehicle. In a conventional sedan retrofitted for use as a taxicab, the front passenger seating area amounts to wasted space. In the preferred embodiment, since only the driver's seat rather than the entire front seating area is enclosed, the area that would be taken up by the front passenger seating area is instead made available for a wheelchair-bound passenger. That will be made clearer below with reference to FIG. 12.

FIG. 10C shows the driver's enclosure 1000 from above. The driver's seat 1008 is configured to provide an upright driving position and good visibility, similarly to the driving positions in tall stations wagons. A console 1010 provides compartments to store whatever the driver will need for a typical day, within easy reach of the driver.

The driver's enclosure 1000 is of modular construction. In particular, the upper portion forming a partition is provided as a module, since some jurisdictions require such a partition, while others forbid it.

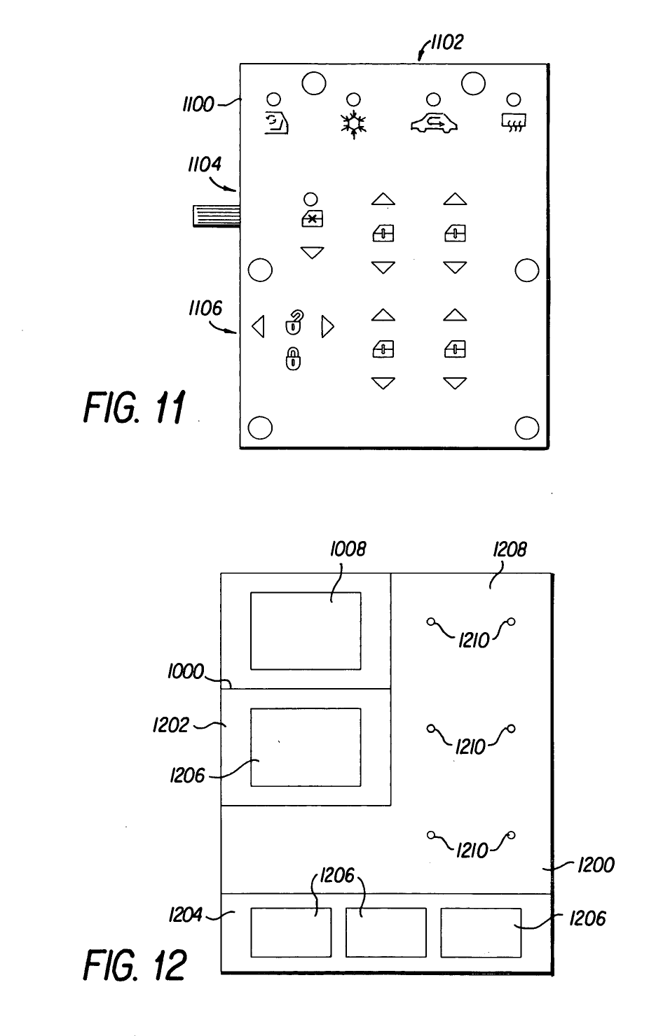

FIG. 11 shows a control panel 1100. The control panel 1100 includes conventional controls such as HVAC controls 1102 and window controls 1104. In addition, the control panel includes controls 1106 to allow the driver to lock and unlock the doors on only one side of the vehicle. As explained above, the driver can use the controls 1106 to prevent a passenger from opening a door into traffic. Interior lights indicate to the passenger which door is unlocked. Exterior lights (shown in FIG. 1B as 102) indicate to other drivers which door is about to open.

FIG. 12 shows a view from above of the interior seating area 1200 of the vehicle. The driver's enclosure is shown as 1000 and has been described above. Bench seats 1202, 1204 provide seating for four. The seats have cushions 1206 that are removable for washing or replacement and for access to the fuel pump. An area 1208 is provided for a passenger using a mobility aid. Since driver's enclosure 1000 encloses only the driver's seat rather than the entire front passenger area, the area 1208 extends into the front passenger area. As a result, the area is larger than required by ADA regulations, i.e., 32″×74″ as opposed to 30″×48″. While such dimensions do not allow ADA-compliant accommodations for two wheelchair-bound passengers, they do allow ADA-compliant accommodations for one wheelchair-bound passenger in one of two positions. Of course, an enlarged vehicle could provide ADA-compliant accommodations for two. Six anchor points 1210 are provided on the floor in that area for anchoring restraints for the wheelchair. An example of the restraints that can be used is the Q'Straint restraining system, sold by Q'Straint of Fort Lauderdale, Fla., U.S.A. The restraints, when not in use, are stored under the driver's seat 1008.

A screen can be provided in the engine's air intake to filter out debris such as pigeon feathers. That is not a common problem with vehicles owned by families. However, given the time each day when a taxicab is driven, rather than parked, it is a significant problem with taxicabs.

While a preferred embodiment of the present invention has been disclosed above, those skilled in the art who have reviewed the present disclosure will readily appreciate that other embodiments can be realized within the scope of the present invention. For example, dimensions and other numerical values are illustrative rather than limiting, as are disclosures of specific suppliers of parts. Also, the seating configuration can be changed as needed. Moreover, the invention can be implemented with fewer than all of the special features disclosed above with regard to the preferred embodiment. Furthermore, while the invention has been disclosed as compliant with U.S. regulations, it can be implemented for the regulations of any other country. In addition, the vehicle is not limited to its disclosed intended use as a taxicab for persons with disabilites, For example, it could be used as a delivery vehicle or as a family car. Therefore, the present invention should be construed as limited only by the appended claims.

We claim:

1. A vehicle comprising:
a vehicle body defining a passenger compartment;
a flat floor in the vehicle body, the flat floor comprising an open flat area; and
a ramp cartridge mounted under the floor of the vehicle and at least partially under the flat area, the ramp cartridge comprising:
a ramp for being stored in a first position under the floor when not in use and for being slid out from under the floor from the first position to a second position in which the ramp is extended to a curb to allow access from the curb to the flat area, and then back to the first position;
guide rails and bearings for guiding the ramp when the ramp is slid between the first and second positions; and
bearings on the guide rails for facilitating movement of the ramp relative to the guide rails.

2. The vehicle of claim 1, wherein the ramp, when in the second position and in contact with the curb, is at a slope not exceeding 1:4.

3. The vehicle of claim 1, wherein the ramp comprises a pair of guide rails mounted on an upper surface of the ramp, the guide rails being attached to the upper surface of the ramp by spring hinges so that when the ramp is in the first position, the guide rails are flat against the upper surface of the ramp, whereas when the ramp is in the second position, the guide rails are upright.

4. The vehicle of claim 1, wherein the ramp cartridge further comprises a door at a location from which the ramp exits the cartridge when the ramp is slid from the first position to the second position, the door being openable and closable and positionable to define a threshold at a top of the ramp when the ramp is in the second position.

5. The vehicle of claim 1, further comprising:
an engine at a front portion of the vehicle body;
a transmission adjacent to the engine;
a differential and drive shaft at a rear portion of the vehicle body; and
a drift shaft for transferring power from the transmission to the differential, the drive shaft comprising:
a first portion extending rearward and downward from the transmission;
a rotary joint at an end of the first portion remote from the transmission; and
a second portion extending from the rotary joint to the differential.

6. The vehicle of claim 1, wherein:
the passenger compartment comprises a front seating area including a driver's seat and a rear seating area; and
the flat area extends into at least part of the front seating area and into at least part of the rear seating area.

7. The vehicle of claim 6, further comprising a driver's enclosure surrounding the driver's seat and separating the driver's seat from the flat area.

8. The vehicle of claim 7, wherein the driver's enclosure comprises a window between the driver's seat and the flat area, and wherein the window is mounted for rotary movement between an open position and a closed position.

9. The vehicle of claim 1, further comprising:
at least one door on a driver's side of the vehicle body;
at least one door on a passenger's side of the vehicle body; and
a switch, controllable by the driver, for selectively unlocking either (i) only the at least one door on the driver's side or (ii) only the at least one door on the passenger's side.

10. The vehicle of claim 9, further comprising lights for indicating which door the driver has unlocked.

11. The vehicle of claim 1, further comprising at least one passenger seat with a removable cushion.

12. The vehicle of claim 11, further comprising a fuel pump, and wherein the removable cushion is removable to provide access to the fuel pump.

13. The vehicle of claim 1, further comprising:
at least four doors for entry into the passenger compartment; and
exterior door panels on the at least four doors, wherein the exterior door panels on the at least four doors are either identical to one another or mirror images of one another, whereby only two types of exterior door panels are provided.

14. The vehicle of claim 13, further comprising four fenders, wherein the four fenders are either identical to one another or mirror images of one another, whereby only two types of fenders are provided.

15. The vehicle of claim 14, further comprising front and rear bumpers which are identical.

16. The vehicle of claim 15, further comprising four bumper corners which are identical.

17. The vehicle of claim 1, further comprising a plurality of windows including a windshield, wherein all of said windows are flat.

18. The vehicle of claim 1, further comprising a plurality of anchor points in the flat area for restraining a mobility aid.

19. The vehicle of claim 1, wherein the flat area is of sufficient size to accommodate a person in a mobility aid.

20. The vehicle of claim 19, wherein:
the passenger compartment comprises a front seating area including a driver's seat and a rear seating area; and
the flat area extends into at least part of the front seating area and into at least part of the rear seating ara.

21. The vehicle of claim 20, further comprising a plurality of anchor points in the flat area for restraining the mobility aid.

22. A vehicle comprising:
a vehicle body;
a flat floor in the vehicle body;
an engine at a front portion of the vehicle body;
a transmission adjacent to the engine;
a differential and drive shaft at a rear portion of the vehicle body; and
a drift shaft for transferring power from the transmission to the differential, the drive shaft comprising:
a first portion extending rearward and downward from the transmission;
a rotary joint at an end of the first portion remote from the transmission; and
a second portion extending from the rotary joint to the differential.

23. The vehicle of claim 22, further comprising a ramp for being slid from a first position under the floor to a second position in which the ramp is extended to a curb, wherein the ramp in the second position and in contact with the curb is at a slope not exceeding 1:4.
